(19) United States
(12) Patent Application Publication
(10) Pub. No.: US 2012/0011944 A1
(43) Pub. Date: Jan. 19, 2012

(54) PATHOGEN SAMPLING PROTOCOLS AND SYSTEMS

(76) Inventors: Jared G. Maughan, Twin Falls, ID (US); Wayne D. Carlsen, Riverton, UT (US); Joshem Coy Gibson, West Jordan, UT (US); Kevin Joseph Church, Twin Falls, ID (US)

(21) Appl. No.: 12/986,029

(22) Filed: Jan. 6, 2011

Related U.S. Application Data
(60) Provisional application No. 61/292,759, filed on Jan. 6, 2010.

(51) Int. Cl. G01N 1/14

(52) U.S. Cl. 73/864.34

(57) ABSTRACT

A system is disclosed for sampling contaminants from a soft test surface that includes a vacuum sampling device. The vacuum sampling device includes a spray port that is in fluid communication with source of sterilized sampling fluid, and which delivers a quantity of sampling fluid onto the soft test surface, a suction head having an outer casing surrounding an open-faced suction cavity that is in communication with a vacuum source and which retrieves the sampling fluid from the test surface, and a storage container for holding the retrieved sampling fluid. The system further includes a retention screen positioned between the test surface and the suction head, and which prevents the soft test surface from substantially occluding suction and reducing mobility of the suction head when engaging the soft test surface.

### PRIORITY DATA

This application claims the benefit of U.S. provisional patent application Ser. No. 61/292,759, filed on Jan. 6, 2010, which is incorporated herein by reference.

### FIELD OF THE INVENTION

The field of the invention relates generally to vacuum-based particulate, contaminant and pathogen sampling systems.

### BACKGROUND OF THE INVENTION

Particulate, contaminant and pathogen sampling is a necessary activity in many industries. Particularly, those industries which provide products for human consumption have significant cleanliness and safety requirements in order to minimize consumer harm. As such, various mechanisms and tools have been used to sample products and production equipment in order to verify cleanliness levels and to control quality. It is also important in industries where the presence or distribution of a particular additive or background bacteria is necessary for product quality.

The development of sampling equipment has occurred in response to sampling needs, and as new products have emerged, new sampling methods and systems have also been developed. Increased government regulation in various industries has also contributed to the need for additional contaminant and pathogen sampling, and thus spawned development of sampling devices capable of meeting such requirements.

Many of the challenges of effective particulate, contaminant and pathogen sampling arise from the type of surface to be sampled and the type and range of contaminant or pathogen for which testing is to be conducted. Surfaces of different materials and of different physical properties can each pose specific challenges to effective contaminant and pathogen sampling.

### SUMMARY OF THE INVENTION

Accordingly, the present invention provides systems and methods for sampling contaminants from a soft test surface. In one embodiment, such a system may include: a vacuum sampling device having: 1) a spray port in fluid communication with source of sterilized sampling fluid and which delivers a quantity of sampling fluid onto the soft test surface; 2) a suction head having an outer casing surrounding an open-faced suction cavity in communication with a vacuum source and which retrieves the sampling fluid from the test surface; 3) a storage container for holding the retrieved sampling fluid; and 4) a retention screen positioned between the test surface and the suction head, said screen preventing the soft test surface from substantially occluding suction and reducing mobility of the suction head when engaging the soft test surface. In some aspects, the screen may be affixed to the suction head. In other aspects, the screen may be part of a template or other device, or by itself and used in connection with the suction head by placement between the suction head and the surface to be sampled during use.

In another aspect of the present invention, a method of sampling contaminants from a soft test surface may include: 1) placing a sampling template having a perimeter ring over a sampling area on the soft test surface; 2) placing a suction head of a vacuum sampling device within the perimeter ring, so that an outer casing of the suction head maintains contact with an inner surface of the perimeter ring and a contact edge of a suction cavity defined by the outer casing is adjacent the test surface; 3) depositing a quantity of sampling fluid onto the test surface through a spray port in the vacuum sampling device in fluid communication with source of sterilized sampling fluid; 4) retrieving the sampling fluid from the test surface with a partial vacuum created in the suction cavity, the suction cavity being in communication with a source of vacuum; 5) preventing the soft test surface from substantially occluding suction of the suction head or being pulled into the sample when engaging the soft test surface with a retention screen positioned between the test surface and the suction cavity; and 6) directing the retrieved sampling fluid into a storage container.

In yet another aspect of the present invention, a method of preventing substantial occlusion of a vacuum cavity in a suction head on a vacuum sampling device during contaminant sampling with the sampling device may include positioning a retention screen between the test surface and the suction head. In some aspects, the screen may be affixed or attached to the suction head. In other aspects, the screen may be part of a template or other device, or by itself and used in connection with the suction head by placement between the suction head and the surface to be sampled during use.

Features and advantages of the present invention will be apparent from the detailed description that follows, and when taken in conjunction with the accompanying drawings together illustrate, by way of example, features of the invention. It will be readily appreciated that these drawings merely depict representative embodiments of the present invention and are not to be considered limiting of its scope, and that the components of the invention, as generally described and illustrated in the figures herein, could be arranged and designed in a variety of different configurations.

### BRIEF DESCRIPTION OF THE DRAWINGS

FIG. 1 illustrates a system for sampling contaminants from a soft test surface, in accordance with a representative embodiment of the present invention;

FIG. 2 illustrates a side view of a sampling device, in accordance with the embodiment of FIG. 1;

FIG. 3 illustrates a bottom view of a vacuum suction head, in accordance with the embodiment of FIG. 1;

FIG. 4 illustrates a bottom view of a vacuum suction head, in accordance with another embodiment of the present invention;

FIGS. 5A and 5B together illustrate various components of a complete vacuum sampling system, in accordance an embodiment of the present invention;

FIG. 6 illustrates a sampling template, in accordance with the embodiment of FIG. 1;

FIGS. 7A-7D illustrate method steps for sampling contaminants from a soft test surface, in accordance with an embodiment of the present invention; and

FIG. 8 is a flowchart depicting a method for sampling contaminants from a soft test surface, in accordance with another embodiment of the present invention.

### DETAILED DESCRIPTION OF EXEMPLARY EMBODIMENTS

The following detailed description makes reference to the accompanying drawings, which form a part thereof and in which are shown, by way of illustration, various representative embodiments in which the invention can be practiced. While these embodiments are described in sufficient detail to enable those skilled in the art to practice the invention, it should be understood that other embodiments can be realized and that various changes can be made without departing from the spirit and scope of the present invention. As such, the following detailed description is not intended to limit the scope of the invention as it is claimed, but rather is presented for purposes of illustration, to describe the features and characteristics of the representative embodiments, and to sufficiently enable one skilled in the art to practice the invention. Accordingly, the scope of the present invention is to be defined solely by the appended claims.

Furthermore, the following detailed description and representative embodiments of the invention will best understood with reference to the accompanying drawings, wherein the elements and features of the embodiments are designated throughout.

As used herein, the term “contaminants” can be taken broadly to include particulates, contaminants, and pathogens, and/or specific additives, surface coatings and background bacteria, which may be beneficial or even required for product quality.

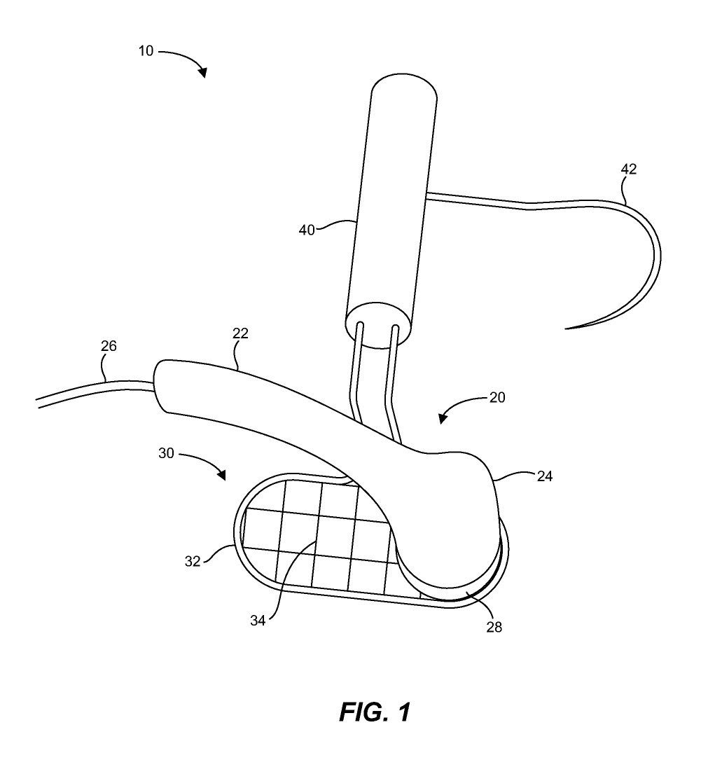

Illustrated in FIGS. 1-8 are several representative embodiments of a system for sampling contaminants from a soft test surface, which embodiments also include various methods and protocols for sampling contaminants from a soft test surface. As described herein, the present invention and protocols for sampling contaminants provides several significant advantages and benefits over other contaminant sampling systems and methods. However, these recited advantages are not meant to be limiting in any way, as one skilled in the art will appreciate that other advantages may also be realized upon practicing the present invention.

FIG. 1 shows an exemplary system 10 for sampling contaminants from a soft test surface. The system includes a vacuum sampling device 20 such as a sampling head, which can further include a handle grip 22, a suction head 24, and flexible tubing 26 connecting components in the suction head to both a pressurized sampling fluid source and a vacuum source, described in further detail below. Pressurized sampling fluid can be delivered to the soft test surface via the sampling device. The sampling device can also retrieve sampling fluid from the soft test surface after it has been deposited thereon. Retrieved sampling fluid can be delivered to a collection reservoir by the vacuum source. Thus, the flexible tubing can include a channel for delivering sampling fluid to the test surface and a channel for retrieving sampling fluid from the test surface. In one aspect, there may be separate flexible tubing for delivering sampling fluid and for retrieving sampling fluid.

The sampling system 10 can also include a sampling area template 30, which has a perimeter ring 32 that is configured to contact an outer casing 28 of the suction head 24, and to guide the suction head over a pre-determined sampling area of the soft test surface during the sampling process. The outer casing or contact ring 28 surrounds a circular or annular open-faced suction cavity, which is also discussed in further detail below.

The sampling area template can have a retention grid 34 or screen, which spans the lower portion of the perimeter ring and is maintained in a position between the test surface and the suction head. The retention grid can prevent the soft test surface from being sucked up and occluding the suction provided by the suction head, and from reducing or limiting the mobility of the suction head while it is engaged with the soft test surface during the sampling process. In one aspect, the sampling area template can be coupled to a handle 40 to allow a user to manipulate the sampling area template in position on the soft test surface. In another aspect, the sampling area template can be coupled to an accessory tool, such as a meat hook 42 or a scraper (not shown). The meat hook can be used to position the soft test surface for sampling. The scraper can be used to prepare the soft test surface for sampling by removing a top layer of material from the soft test surface.

In a particular aspect, the sampling area template 30 can include a perimeter ring 32 without a retention grid or screen. In this case, the perimeter ring can be used to tension the soft test surface, such as by pressing the perimeter ring into the soft test surface. This tensioning of the soft test surface within the perimeter ring can tighten the test surface to approximate a rigid or semi-rigid surface in the local test surface area within the perimeter ring. In this state, the possibility for the test surface to be sucked up and occlude the suction provided by the suction head is minimized or reduced. Thus, the perimeter ring can be used to alter the surface characteristics of the soft test surface to prevent or minimize occlusion of the suction head. It should be recognized that a device that can cause tensioning of the soft test surface, such as the perimeter ring, need not be any particular shape, size, or geometry. Therefore, such a device need not form a closed “ring” or perimeter and can be “open” on any side. For example, a tensioning device can be “U-shaped.” In another aspect, a tensioning device can be configured to provide a plurality of test surface contact points, such as ends of fingers or tines contacting the soft test surface. Thus, a test surface tensioning device can be device that can contact a soft test surface and put the test surface into tension over at least a local area of the test surface.

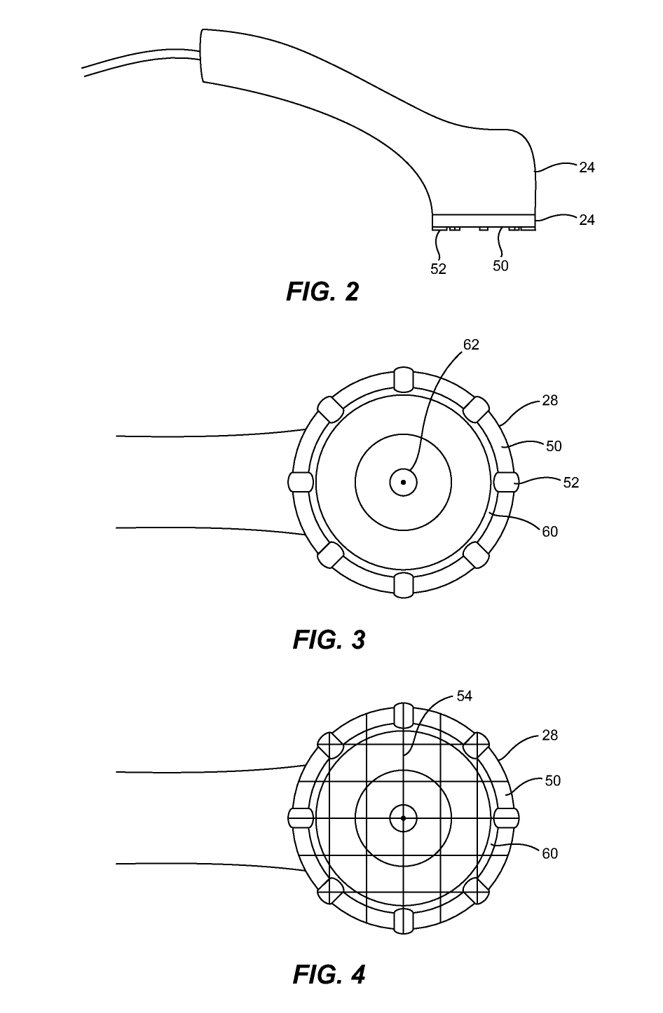

The suction head 24 is shown in more detail in FIGS. 2-4. For example, as illustrated in FIG. 2, the outer casing or contact ring 28 of the suction head 24 can include a bottom contact edge 50. The bottom contact edge may be brought into contact with the soft test surface during the sampling process. In one aspect, the contact edge can have downwardly projecting contact ribs 52. The contact ribs can serve to elevate the contact edge a short distance above the test surface so that the air can flow into the suction head from outside the suction head. In one aspect of the present invention, moreover, the contact ribs can also be used to scrape or abrade the soft test surface to expose a fresh surface prior to sampling the test surface.

As illustrated in FIG. 3, the outer casing or contact ring 28 of the suction head 24 can surround a circular or annular open-faced suction cavity 60. In one aspect, the suction cavity can be integrally formed with the contact ring and can be adjacent to the bottom contact edge, which may be brought into contact with the soft test surface during the sampling process.

The suction head 24 can also include a spray port 62 that is in fluid communication with a pressurized source of sterilized sampling fluid and which can deliver a quantity of sampling fluid onto the soft test surface. The delivery of the sampling fluid to the test surface by the spray port can be controlled by switches, valves, etc. as desired. For example, a valve (not shown) can control fluid flow out of the spray port. The valve can be associated with the vacuum sampling device 20 or the valve can be remote from the sampling device, such as by being associated with a sampling fluid source. The valve can be controlled by a valve actuator such as a lever, knob, switch, or other mechanical or electronic device that can actuate a valve.

The annular open-faced suction cavity 60 can be in communication with a vacuum source, which can retrieve the sampling fluid from the test surface after application. As with the delivery of the sampling fluid to the test surface, the vacuum to retrieve the sampling fluid can be controlled by switches, valves, etc. to activate a vacuum at the suction cavity as desired. The contact ribs 52 can serve to elevate the contact edge a short distance above the test surface so that the air can flow into the suction cavity from outside the suction head. In one aspect, the contact ribs can be used to scrape or abrade the soft test surface to expose a fresh surface prior to depositing the sample fluid.

In another aspect of the present invention, as shown in FIG. 4, a retention screen 54 can be attached directly to the suction head 24 to cover the open face of the suction cavity 60. The retention screen can be integrally formed with the contact ring 28 and/or contact edge 50 of the suction cavity, resulting in a unitary structure that reduces or eliminates cavities or voids, which can capture unwanted debris or soft surface material. The retention screen can also be formed separately and attached at a later time, especially when a variety of interchangeable retention screens are provided for each sampling head, which can then be interchanged as need to accommodate a variety of soft test surfaces. The retention screen may be rigid, semi-rigid or flexible. Moreover, the gaps in the screen may be designed to prevent certain sizes or shapes of debris or sample surface from passing through the screen.

As describe above, a retention screen 34, 54 can be one of a plurality of interchangeable retention screens configured to interface with or attach to the perimeter ring of the sampling area template or to the contact ring of the suction head, each with a particular gap sizing or spacing configured to accommodate a particular type of soft surface. Alternatively, in another aspect of the present invention the gaps or spacing in a single multi-purpose retention screen can be selectively adjustable to accommodate a variety of soft surfaces.

Whether a retention screen 34, 54 or grid is attached to the perimeter ring 32 of the sampling area template (FIG. 1) or to the contact ring of the suction head (FIG. 4), the retention screen or grid can be substantially rigid so that the soft test surface can bulge upward slightly into the openings in the grid. In another aspect, however, the retention screen can be bendable or flexible to substantially conform to the soft test surface.

In another aspect of the present invention, moreover, a retention grid or screen not having a template perimeter ring to guide the suction head can be placed between the test surface and the suction head, so that the suction head may be free to move over a larger swath of the sampled test surface and increase the area of the sampled surface. As may be appreciated by one of skill in the art, the retention screen can be attached to the perimeter ring of the sampling area template, or can be an individual component of the sampling system that is separate from the suction head.

It is to be appreciated, moreover, that the retention screen can be selected or modified to best accommodate a particular type of soft test surface, which surfaces may include, but are not limited to: meat, meat trimmings, vegetables, fruits, grains, food products, skin, living tissue, fabrics, etc., and combinations thereof. Consequently, to accommodate these various type of test surfaces, the retention screen may comprise, but is not limited to, a metal grid, a metal mesh, a plastic mesh, a fabric, a non-woven barrier, or a selective barrier, or combinations thereof, etc., depending upon the application.

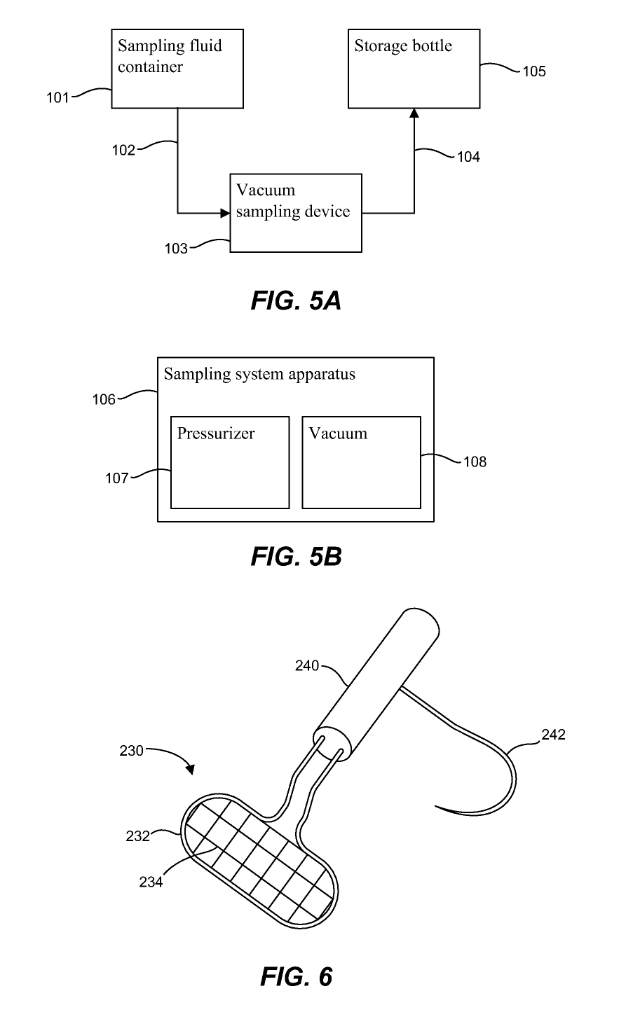

Various additional components of a complete vacuum sampling system are shown in FIGS. 5A and 5B. As illustrated in FIG. 5A, the sampling system can include a flexible bag or container 101 of sampling fluid, which can be pressurized and directed through tubing 102 to a spray port of the sampling device 103. The sampling device can be as in any of the examples illustrated above with reference to FIGS. 1-4. A storage bottle or container 105 can receive and hold sampling fluid retrieved from the soft test surface by the suction head of the sampling device 104. The storage container 105 can receive the sampling fluid from the sampling device via tubing 103. As illustrated in FIG. 5B, the sampling system can also include a sampling system apparatus 106 that can house a pressurizer 107 to pressurize the fresh sampling fluid for delivery to the sampling device from container 101 and a vacuum generation device 108 to create a vacuum for the sampling device 103 to retrieve sampling fluid from the test surface and to deliver the sampling fluid to the storage container 105. The sampling system apparatus can be fluidly connected to the sampling fluid container, the sampling device, and/or the storage container by tubing. In one aspect, the sampling fluid container 101 and/or the storage container 105 can be removably attachable or integral with the sampling system apparatus 106. In another aspect, the sampling system apparatus 106 can be configured to store or hold the sampling device 103 when the sampling device is not in use.

Illustrated in FIG. 6 is an isolated view of a sampling area template 230, in accordance with one representative embodiment of the present invention. As described above, the template can include a perimeter ring 232 which can contact the outer casing of the suction head and guide the suction head over a pre-determined sampling area of the test surface (see also FIG. 1). In one aspect, the pre-determined sampling area (i.e. the area which is contacted by the spray solution which is then recovered for analysis) can be about twelve square centimeters. In another aspect the shape of the perimeter ring can correspond to a dimension of the outer casing of the suction head. For instance, the perimeter ring can have the shape of a slot with rounded ends while the suction head can have a circular shape (as shown in both FIGS. 1 and 6), and the width of the slot and the radius of the rounded ends of the template can match the diameter and radius of the suction head, respectively, so that the suction head can fit neatly within and can be guided by the perimeter ring. Although shown as a rounded slot in the illustrated embodiments, the perimeter ring of the template can be formed into other shapes, including a round shape, an oblong shape, an elliptical shape, a rectangular shape, a rectangular shape with rounded ends, a U-shape, etc., as well as combinations thereof. In other aspects, there may be little or no correspondence between the shape and size of the spray head and the shape and size of the template.

With further reference to FIG. 6, in one aspect the sampling area template can also include a retention screen 234 or grid that spans the space inside the perimeter ring, in which case another retention screen may or may not be included with the suction head of the vacuum sampling device to better prevent the occlusion of the vacuum cavity by the soft test surface or tissue. For instance, in one embodiment the retention screen spanning the perimeter ring of the template can be a generally course metal grid, while a retention screen on the suction device can be a fine plastic mesh.

In another aspect, the sampling area template can be permanently or interchangeably coupled to an accessory tool, such as a meat hook 242 or scraper. In one example, the meat hook can be permanently or interchangeably attached to a handle 240. In a particular aspect, a second accessory tool (not shown), such as a scraper, can be permanently or interchangeably attached to a second handle (not shown), which can be interchangeably attached to the sampling area template. In this way, handles can be removably interchanged to provide different grips and/or accessory tools.

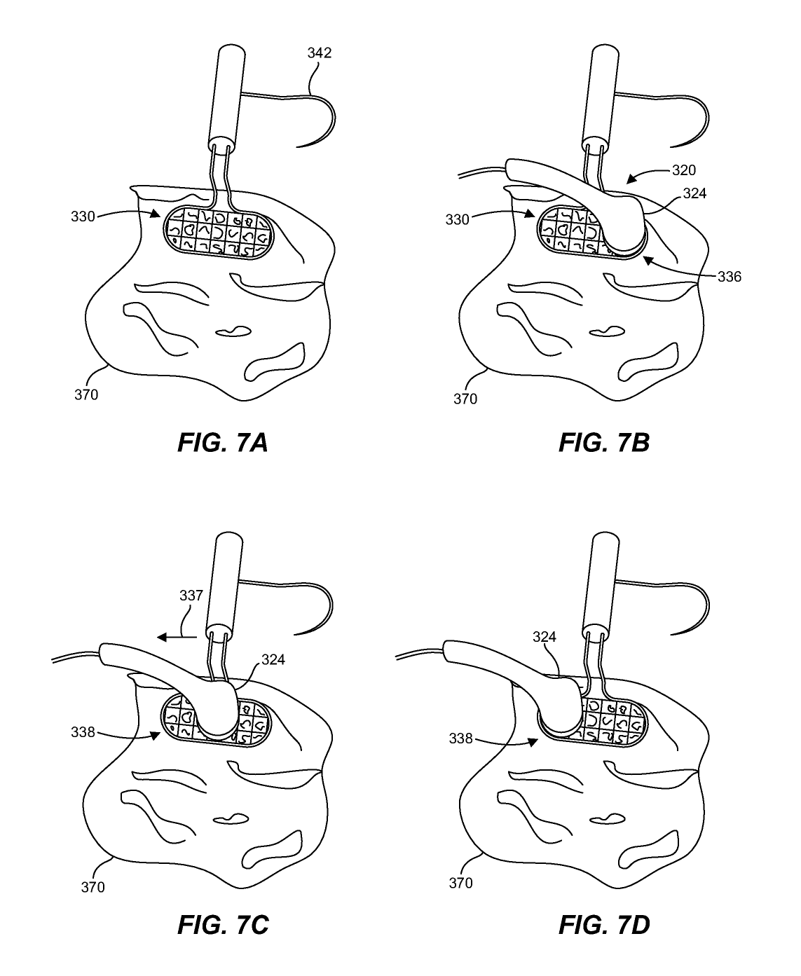

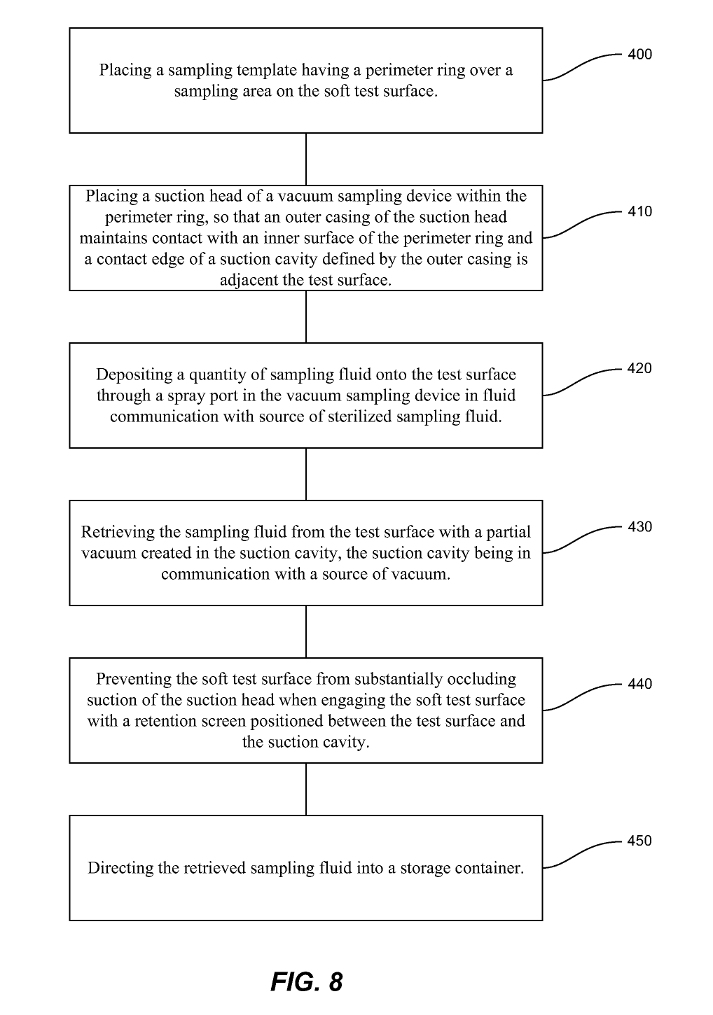

FIGS. 7A-7D and FIG. 8 illustrate and describe one or more methods for sampling contaminants from a soft test surface, in accordance with other representative embodiments of the present invention.

For example, FIGS. 7A-7D illustrate a method for sampling contaminants from a soft test surface, in accordance with an example of the present disclosure. In one aspect, a soft test surface can be selected, such as a piece of meat 370. The meat can be positioned using the hook 342. As shown in FIG. 7A, a sampling screen 330 can be placed on top of the meat. Sufficient pressure can be used to achieve a substantially continuous interface between the meat and the screen. As shown in FIG. 7B, a sampling head 324 of a sampling device 320 can be disposed on the screen, such as at a first end or position 336 of the screen. Without dispensing sampling fluid on the meat, the sampling head can be moved in a direction 337 toward a second end or position 338 of the screen, as shown in FIG. 7C. FIG. 7D illustrates the position of the sampling head at the second end of the screen. The sampling head can be moved in an opposite direction back to the starting position at the first end of the screen. As used herein, moving the sampling head from the first end or position of the screen to the second end or position of the screen and back to the first end or position of the screen is considered one back and forth motion. In one aspect, the sampling head can be moved back and forth across the sampling screen two or three times to scrape the surface of the meat under the screen without sampling fluid being present. These “dry” strokes of the sampling head can prepare the top surface of the meat for sampling.

Following the “dry” strokes of the sampling head and with the sampling head in position at the first end of the screen, sampling fluid can be dispensed onto the surface of the meat. In one aspect, the sampling head can dispense the sampling fluid. In another aspect, the sampling head can also vacuum sampling fluid off the surface of the meat. As the sampling fluid is being dispensed and vacuumed, the sampling head can be moved back and forth across the sampling screen, as illustrated in FIGS. 7B-7D and as discussed above. In one aspect, the sampling head can be moved back and forth over the screen two or three times. These “wet” strokes of the sampling head can dispense sampling fluid to, and retrieve sampling fluid from, the surface of the meat.

The directions and illustrations shown and discussed above with reference to FIGS. 7A-7D are merely examples. Thus, it should be recognized that the sampling head can be disposed in any position on the sampling screen and moved in any direction to scrape the top surface of the meat under the screen. In general, one back and forth motion can take about one second to complete. However, this time can vary depending on the size of the screen, the size of the sampling head, and/or the distance to be traversed by the sampling head. In one aspect, the “dry” and “wet” strokes of the sampling head can be repeated on a given piece of meat as required to fulfill an inspection requirement. In another aspect, the above sampling strategy can be used to sample 30 sites, which can be pooled in a single collection bottle. Of course, collection bottles can vary in size and can be replaced in the sampling system as needed. It should also be recognized that the sampling device can be prepared for use prior to sampling by sanitizing the sampling screen and/or the hook.

Further aspects of the method are illustrated in FIG. 8. For instance, one method can include the steps of placing a sampling template having a perimeter ring over a sampling area on the soft test surface 400. The method can further include placing a suction head of a vacuum sampling device within the perimeter ring, so that an outer casing of the suction head maintains contact with an inner surface of the perimeter ring, and a contact edge of a suction cavity defined by the outer casing/contact ring is adjacent the test surface 410. The method can also include depositing a quantity of sampling fluid onto the test surface through a spray port in the vacuum sampling device, or suction head, that is in fluid communication with a source of sterilized sampling fluid 420. Additionally, the method can include retrieving the sampling fluid from the test surface with a partial vacuum created in the suction cavity by a vacuum source in communication with the suction cavity 430. The method can also include preventing the soft test surface from substantially or partially occluding suction of the suction head when engaging the soft test surface with a retention screen that is positioned between the test surface and the suction cavity 440. Furthermore, the method can include directing the retrieved sampling fluid into a storage container 450. It should be understood that the method steps need not be performed sequentially and can be, for example, performed simultaneously.

The steps of spraying the sterile solution onto the surface and vacuuming it from the surface can be done simultaneously. In another aspect of the present invention, however, the steps of spraying or depositing the sterile solution into the soft surface and vacuuming it back up from the surface can be accomplished in separate steps, and with non-uniform patterns. For instance, the sterile solution can be applied with one spraying stroke, and subsequently retrieved with two or more suction or vacuuming strokes. Additionally, the depositing and/or retrieving strokes can be made in a single direction, in both directions, in either direction, or can be direction-specific as the capability for penetrating deeper below the top layer of the soft surface and better sampling the lower layers may also be direction-dependent. As described above, the retention screen can be attached to the sampling area template and span the perimeter ring, or to the suction head and cover the open face of the suction cavity, or both.

In an alternative embodiment, the suction head may be used within the perimeter of the template with perhaps some contact with the inner surface of the perimeter ring, but without maintaining contact throughout the sampling procedure. In other aspects, the suction head may be swept back and forth across the sample substrate within the perimeter ring and may only touch the inner surface of the perimeter ring occasionally.

In another aspect, the method can further include the step of scraping the soft test surface with the contact edge of the suction cavity and exposing a fresh surface prior to depositing the sample fluid. This can be accomplish by moving the suction head back and forth within the perimeter ring several times so that the contact ribs described above can rub against the soft surface, and prior to performing the same motion while depositing and removing the sampling fluid with the vacuum sampling device. It may also be accomplished with the embodiment of the invention wherein the screen is attached to the sampling head and/or the screen itself is used to scrape the soft sample surface.

In another aspect, the method can further include the step of marking the soft test surface with an indicator mark to identify the location of the sampled test surface. This can be accomplished in a variety of ways. For example, the indicator mark can comprise a food-grade ink, and the marking device itself can be an ink applicator located in the contact edge of the suction cavity, an ink applicator located in the perimeter ring of the sampling area template, or even a marking dye included with the sampling fluid. Further, a separate mechanism for marking can be used in connection with the template, such as a permanent pen or other marking mechanism by drawing a line around the sample area using the template as a guide. Alternatively, mechanical methods could also be used to mark the location of the sampled test surface, such as with a serration edge located in a perimeter ring of a sampling area template which can cut, indent, or otherwise mark the soft test surface in a particular fashion.

The foregoing detailed description describes the invention with reference to specific representative embodiments. However, it will be appreciated that various modifications and changes can be made without departing from the scope of the present invention as set forth in the appended claims. The detailed description and accompanying drawings are to be regarded as illustrative, rather than restrictive, and any such modifications or changes are intended to fall within the scope of the present invention as described and set forth herein.

More specifically, while illustrative representative embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, any steps recited in any method or process claims, furthermore, may be executed in any order and are not limited to the order presented in the claims. The term “preferably” is also non-exclusive where it is intended to mean “preferably, but not limited to.” Accordingly, the scope of the invention should be determined solely by the appended claims and their legal equivalents, rather than by the descriptions and examples given above.

1. A system for sampling contaminants from a soft test surface, comprising:
a vacuum sampling device having:
a spray port in fluid communication with source of sterilized sampling fluid and which delivers a quantity of sampling fluid onto the soft test surface;
a suction head having an outer casing surrounding an open-faced suction cavity in communication with a vacuum source and which retrieves the sampling fluid from the test surface;
a storage container for holding the retrieved sampling fluid; and
a retention screen positioned between the test surface and the suction head, said screen preventing the soft test surface from substantially occluding suction and reducing mobility of the suction head when engaging the soft test surface.

2. The system of claim 1, wherein the soft test surface is selected from the group consisting of meat, meat trimmings, vegetables, fruits, grains, food products, skin, living tissue, fabrics, and combinations thereof.

3. The system of claim 2, wherein a size of a plurality of gaps in the retention screen is selectively configurable to accommodate a specific soft test surface.

4. The system of claim 1, wherein the retention screen is selected from the group consisting of a metal grid, a metal mesh, a plastic mesh, a fabric, a non-woven barrier, a selective barrier, and combinations thereof.

5. The system of claim 1, wherein the retention screen is flexible to substantially conform to the soft test surface.

6. The system of claim 1, wherein the sampled contaminant is selected from the group consisting of particulates, contaminants, pathogens, surface coatings, beneficial additives and beneficial background bacteria.

7. The system of claim 1, wherein the retention screen is attached to the suction head and covers the open face of the suction cavity.

8. The system of claim 7, wherein the retention screen is integrally formed with a contact edge of the suction cavity to reduce the capture of unwanted debris.

9. The system of claim 1, further comprising a sampling area template having a perimeter ring contacting the outer casing and guiding the suction head over a pre-determined sampling area of the test surface.

10. The system of claim 9, wherein the pre-determined sampling area is about twelve square centimeters.

11. The system of claim 9, wherein the retention screen is attached to the sampling area template and spans the perimeter ring.

12. The system of claim 9, wherein a shape of the perimeter ring corresponds to a dimension of the outer casing of the suction head.

13. The system of claim 9, wherein a shape of the perimeter ring is selected from the group consisting of a round shape, an oblong shape, an elliptical shape, a rectangular shape, a rectangular shape with rounded ends, a U-shape, and combinations thereof.

14. The system of claim 9, further comprising the sampling area template being coupled to an accessory tool.

15. The system of claim 14, wherein the accessory tool is selected from a group consisting of a meat hook or a meat scraper.

16. The system of claim 1, further comprising a marking device for leaving an indicator mark on the sampled test surface.

17. The system of claim 16, wherein the indicator mark comprises a food-grade ink.

18. The system of claim 16, wherein the marking device is selected from the group consisting of an ink applicator located in a contact edge of the suction cavity, an ink applicator located in a perimeter ring of a sampling area template, a marking dye included with the sampling fluid, a serration edge located in a perimeter ring of a sampling area template, and combinations thereof.

19. A method for sampling contaminants from a soft test surface, comprising:
placing a sampling template having a perimeter ring over a sampling area on the soft test surface;
placing a suction head of a vacuum sampling device within the perimeter ring, so that an outer casing of the suction head maintains contact with an inner surface of the perimeter ring and a contact edge of a suction cavity defined by the outer casing is adjacent the test surface;
depositing a quantity of sampling fluid onto the test surface through a spray port in the vacuum sampling device in fluid communication with source of sterilized sampling fluid;
retrieving the sampling fluid from the test surface with a partial vacuum created in the suction cavity, the suction cavity being in communication with a source of vacuum;
preventing the soft test surface from substantially occluding suction of the suction head when engaging the soft test surface with a retention screen positioned between the test surface and the suction cavity; and
directing the retrieved sampling fluid into a storage container.

20. The method of claim 19, wherein the retention screen is attached to the sampling area template and spans the perimeter ring.

21. The method of claim 19, wherein the retention screen is attached to the suction head and covers an open face of the suction cavity.

22. The method of claim 19, further comprising scraping the soft test surface with the contact edge of the suction cavity and exposing a fresh surface prior to depositing and collecting the sample fluid.

23. The method of claim 19, further comprising marking the soft test surface with an indicator mark to identify the location of the sampled test surface.

24. A method of preventing substantial occlusion of a vacuum cavity in a suction head on a vacuum sampling device during contaminant sampling with the sampling device comprising:
positioning a retention screen between the test surface and the suction head.

25. A method for sampling contaminants from a soft test surface, comprising:
disposing a sampling template on a soft test surface;
disposing a suction head of a vacuum sampling device on the sampling template at a first position;
moving the suction head along the sampling template to a second position;
depositing a sampling fluid on the soft test surface;
retrieving the sampling fluid from the soft test surface with a vacuum created in the suction cavity; and
moving the suction head along the sampling template to the first position.
